(19) United States
(12) Patent Application Publication
(10) Pub. No.: US 2007/0230347 A1
(43) Pub. Date: Oct. 4, 2007

(54) Communication interface device and communication method

(75) Inventor: Nobutaka Imamura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 11/588,391

(22) Filed: Oct. 27, 2006

(30) Foreign Application Priority Data
Mar. 31, 2006 (JP) 2006-099352

(51) Int. Cl. H04L 12/56; H04L 12/54; H04L 1/18; H04J 1/16

(52) U.S. Cl. 370/235; 370/428; 370/412; 714/748

(57) ABSTRACT

A node computer includes a communication I/F unit that performs the synchronization process of the packet related to the synchronization process that is conventionally performed by a processor. An interrupt generated every time a packet including the message related to the synchronization process is received can be reduced to one interrupt.

### BACKGROUND OF THE INVENTION

1. Field of the Invention

The present invention generally relates to a communication interface device and a communication method for a computer in parallel computing.

2. Description of the Related Art

There has been know a technique of connecting a plurality of computers to each other, and allowing data to be transmitted and received between the computers by inter-node communication. In recent years, vast improvement has been made in processing performance of computers. Enhanced communication circuit speed between computers has also been achieved. At the same time, overhead that is related to data transmission and reception by inter-node communication remains large. Elimination of the overhead is becoming a bottleneck in data communication by inter-node communication.

As an example of the bottleneck, when an interrupt process is generated in a receiving computer when receiving data, the processing load placed on a processor in the receiving computer increases because the processor need to do the interrupt process.

Japanese Patent Application Laid-open No. 2000-89968 discloses a technique to eliminate such a bottleneck. The computer disclosed in this publication includes a circuit for generating an interrupt process in a processor in a receiving computer when a packet received by serial communication matches a predetermined value. The computer reduces software processing load placed on the processor. The software processing load is caused by data communication. As a result, communication processing speed of data communication is enhanced.

In Japanese Patent Publication No. 2584957, the following communication interface is disclosed. When a first data block and a second data block are consecutively communicated between two computers, a processor in a receiving computer generates an interrupt at the start of transmission and upon termination of transmission of each data block. However, the interrupt generated upon termination of the transmission of the first data block to be consecutively transmitted and the interrupt generated at the start of the transmission of the second data block are generated in close temporal proximity. Therefore, the communication interface device can collectively process the interrupts as one interrupt process. As a result, the overhead placed on the receiving processor because of the interrupt process is reduced. Furthermore, the communication processing speed of data communication can be enhanced.

In recent years, a following parallel computer is becoming a mainstream computing system, in place of a conventional large-scale computer. The parallel computer achieves data processing capability and computing capability for a vast amount of data by connecting a plurality of computers to allow communication and enabling the computers to work together as one computer.

In the parallel computer, a processor in a computer performing data processing may perform processing based on data distributed and allocated to other computers. When the processor performs the processing, the data distributed and allocated to the computers are transmitted by inter-node communication to the computer performing the data processing.

When all data are received by the computer performing the data processing, the computer performing data processing starts data processing.

With the above conventional techniques, the problem of overhead caused by each interrupt process generated during data communication from each computer transmitting data to the computer performing data processing can be solved. However, because the interrupt process is generated every time data is transmitted from each computer and received by the computer performing data processing, frequency of the interrupt process cannot be controlled.

### SUMMARY OF THE INVENTION

It is an object of the present invention to at least partially solve the problems in the conventional technology.

According to an aspect of the present invention, a communication interface device in a computer in a parallel computer that, under a condition that a receiving computer receives data distributed and allocated to a plurality of transmitting computers as a packet, starts processing a received packet, includes an integral-operation performing unit that performs an integral operation for performing a memory operation depending on a packet received from the transmitting computers; and a condition judging unit that judges whether a result of the memory operation performed by integral-operation performing unit fulfills a predetermined condition, every time the integral-operation performing unit performs the integral operation.

According to another aspect of the present invention, a communication method executed on a computer in a parallel computer that, under a condition that a receiving computer receives data distributed and allocated to a plurality of transmitting computers as a packet, starts processing a received packet, includes performing an integral operation for performing a memory operation depending on a packet received from the transmitting computers; and judging whether a result of the memory operation performed at the performing fulfills a predetermined condition, every time the performing is executed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining a conventional parallel computer and issues concerning a synchronization process;

FIG. 2 is a functional block diagram of a parallel computer according to an embodiment of the present invention;

FIG. 3 is a sequence diagram of the synchronization process according to the embodiment; and

FIG. 4 is a schematic for explaining an application example of the embodiment.

### DETAILED DESCRIPTION OF THE PREFERRED EMBODIMENTS

Exemplary embodiments of the present invention are below described with reference to the attached drawings. In the embodiments described below, an example is given in which the invention is applied to a synchronization waiting process (synchronization process) performed by a parallel computer connected to a plurality of computers. The parallel computer performs parallel applications. The parallel computer according to the invention widely includes cluster computers, computers that perform grid computing, and the like. In the embodiments described below, remote direct memory access (RDMA) is a prerequisite. The RDMA is a technology for directly accessing a memory from a remote computer, represented by InfiniBand and Myrinet (registered trademarks). The InfiniBand and Myrinet (registered trademarks) are inter-computer interface standards for parallel computers.

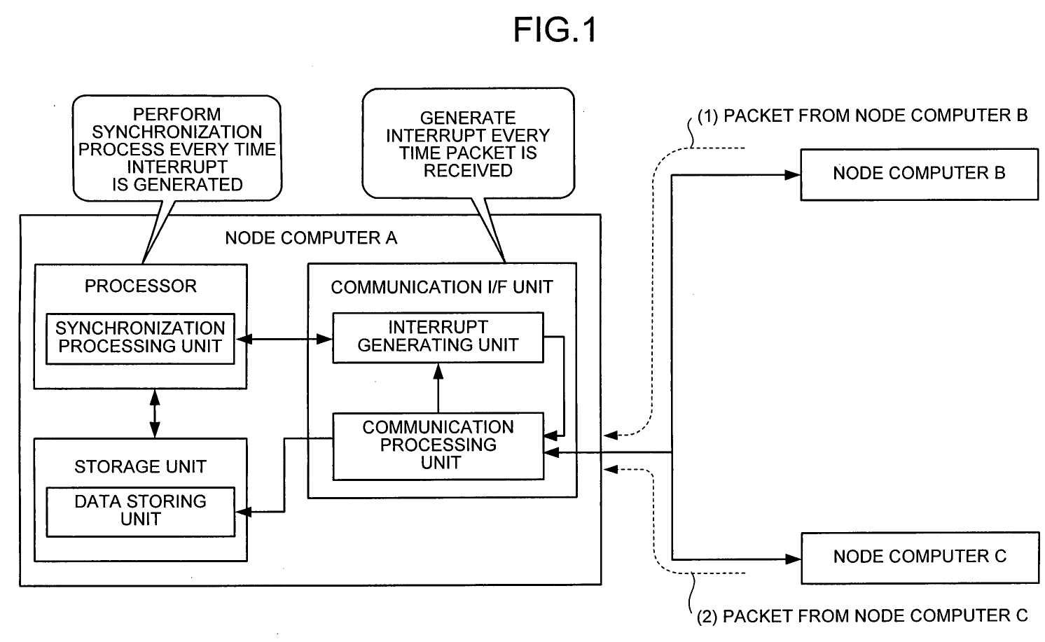

First, a configuration of a conventional parallel computer and issues concerning a synchronization process will be explained. FIG. 1 is a schematic for explaining a conventional parallel computer and the issues concerning the synchronization process. In the conventional parallel computer, node computers A, B, and C are connected to each other, and the node computers can perform communication among each other. In the conventional parallel computer, a problem occurs when a packet is transmitted from the node computer B to the node computer A by message communication and a packet is transmitted from the node computer C to the node computer A by message communication almost simultaneously.

The packet is data requesting a computer to perform an atomic operation and the like corresponding to the packet. The computer is remotely present, via a network. The packet includes data on which the atomic operation is to be performed. The atomic operation prohibits an interrupt until the completion of the atomic operation and does not allow execution of other orders.

The node computer A includes a processor, a storage unit, and a communication interface (I/F) unit. The processor is a central processing unit (CPU) or the like. The storage unit is a memory or the like. The communication I/F unit is a network interface card. The processor further includes a synchronization processing unit. The storage unit further includes a data storing unit. The data storing unit is an area in which data including a received packet is written. The communication I/F unit further includes a communication processing unit and an interrupt generating unit. The communication processing unit performs the atomic operation and the like. The node computers B and C have same or almost same structure as the node computer A.

The synchronization process unit monitors an arrival of transmitted data under software control, every time an interrupt process is generated by an interrupt processing unit. The synchronization process unit monitors the arrival until all data transmitted from a plurality of node computers required for a certain processor process arrive.

When a packet is received from another node computer, the communication processing unit performs a communication processing, such as the atomic operation and the like, depending on the packet and performs a memory operation directly in the data storing unit. In addition, the communication processing unit outputs an instruction to the interrupt generating unit. The instruction is for generating an interrupt process related to data reception in the processor.

The interrupt generating unit makes the synchronization processing unit generate the interrupt process in the processor, based on an interrupt process generating instruction from the communication processing unit. The interrupt generating unit also outputs an instruction to the communication processing unit, based on a send work request (SWR). The instruction is for a transmission of a packet. The SWR is a packet transmission instruction outputted from the processor to an external destination. In addition, based on the packet transmission instruction from the interrupt generating unit to another node computer, the interrupt generating unit transmits a corresponding packet to the other node computer.

First, (1) when a packet including a message related to the synchronization process is received by the node computer A from the node computer B, a message reception is performed based on the reception of the packet. The interrupt process is generated in the processor to perform the message reception. Then, (2) when a packet including the message related to the synchronization process is received by the node computer A from the node computer C, the message reception is performed based on the reception of the packet. The interrupt process is again generated in the processor to perform the message reception.

In this way, the conventional parallel computer generates the interrupt process in the processor every time a plurality of packets on to which the synchronization process is to be performed is received. Then, the parallel computer monitors the arrival of the transmitted packet under software control, every time the interrupt is generated. The parallel computer monitors the arrival until all data transmitted from the node computers required for a certain processor process arrive. As a result, a context switch performed in the processor because of processes being switched is significantly disturbed.

When the atomic operation depending on the packet is to be used via the network by the conventional technology being transitioned as is, exclusive control is performed using spinlock. When the spinlock is used, retries are repeated until a transmitting end releases a lock on a receiving end. The context switch is significantly disturbed due to switching of the processes in the processor in the transmitting end. The switching of the processes occurs because of a generation of waiting due to the retries.

As a result, when the parallel computer runs a distributed application, it is difficult to expect the overall parallel computer to have a high processing capability when performing inter-computer communication, the regardless of how high processing capabilities of individual computers are. The high processing capability of the overall parallel computer cannot be expected because of the frequency of the interrupt processes related to the synchronization process, increased context switch due to the switching of the processes, and increased memory access latency occurring due to purging of cache data.

A communication interface device and the communication method according to the embodiments of the invention focuses on characteristics of the distributed application for performing the above-described message communication. In an application that does not start the process in the processor until a plurality of message packets arrive, the communication interface device and the communication method can eliminate overhead associated with inter-computer communication and enhance the processing capability of the overall parallel computer. The overhead is associated with, for example, the interrupt being generated in the processor every time the message packet arrives and the synchronization process being performed by the processor.

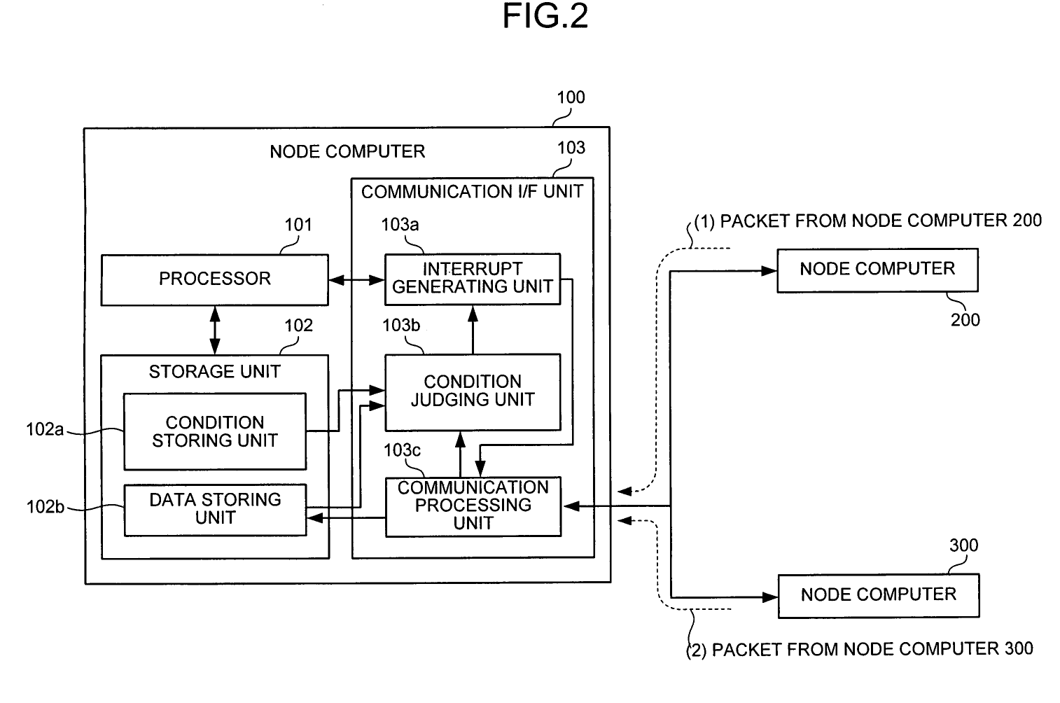

Next, a configuration of the parallel computer according to an embodiment of the present invention will be explained. FIG. 2 is a functional block diagram of the parallel computer according to the embodiment. In the parallel computer according to the embodiment, node computers 100, 200, and 300 are connected to each other, and the node computers can perform communication among each other. The node computers 100 to 300 have same or almost same structure. Therefore, the structure of only the node computer 100 will be explained.

The node computer 100 includes a processor 101, a storage unit 102, and a communication I/F unit 103. The processor 101 is, for example, a CPU. The storage unit 102 is, for example, a memory. The communication I/F unit 103 is a network interface card. The processor 101 according to the embodiment does not have a synchronization processing unit. The storage unit 102 further includes a condition storing unit 102a and a data storing unit 102b. The condition storing unit 102a stores a condition for generating an interrupt. The data storing unit 102b is an area to which data including a received packet is written. The communication I/F unit 103 further includes an interrupt generating unit 103a, a condition judging unit 103b, and a communication processing unit 103c.

The interrupt generating unit 103a generates an interrupt or an event in the processor 101, based on an interrupt process generating instruction from the condition judging unit 103b. The interrupt generating unit 103a outputs an instruction to the communication processing unit 103c, based on the SWR. The instruction is for a transmission of a packet. The SWR is a packet transmission instruction outputted from the processor 101 to an external destination. The communication processing unit 103c transmits the packet to another node computer based on the instruction.

Based on an atomic operation performing notification from the communication processing unit 103c, the condition judging unit 103b reads an interrupt generating condition from the condition storing unit 102a, reads a memory value after memory operation from the data storing unit 102b using the atomic operation, and compares the interrupt generating condition and the memory value. When the interrupt generating condition and the memory value are judged to match as a result of the comparison, the condition judging unit 103b outputs an instruction for generating an interrupt or an event to the interrupt generating unit 103a. In addition, the condition judging unit 103b instructs the communication processing unit 103c to transmit a completion notification to all node computers from which the packets on which the memory operations are based are sent.

An interrupt generating condition is a target value of a value to be finally held in the data storing unit 102b. A value after memory operation in the data storing unit 102b is the value itself stored in the data storing unit 102b. However, the interrupt generating condition and the value after memory operation in the data storing unit 102b are not limited thereto. The interrupt generating condition can be a reception frequency of received packets required for a synchronization process. The value after memory operation in the data storing unit 102b can be a count value of a reception frequency stored in the data storing unit 102b.

It is not necessary that the condition storing unit 102a is in the storage unit 102. The condition storing unit 102a can be an area in the communication I/F unit 103.

The atomic operation performing notification from the communication processing unit 103c is a type of atomic operation. Furthermore, the comparison of the interrupt generating condition and the memory value after memory operation from the data storing unit 102b using the atomic operation is also a type of atomic operation. Still further, the instruction for generating an interrupt outputted to the interrupt generating unit 103a when the interrupt generating condition and the memory value after the memory operation are judged to match as a result of the comparison is also a type of atomic operation. These atomic operations are newly added to the communication I/F unit 103 according to the embodiment.

When the communication processing unit 103c receives a packet including a message related to the synchronization process from another node computer, the communication processing unit 103c performs the communication processing, such as the atomic operation and the like, according to the packet and performs memory operation directly in the data storing unit 102b. When the communication processing unit 103c first receives a packet including a message related to a series of synchronization processes, the communication processing unit 103c exclusively controls information indicating that the synchronization process is being performed using a synchronization process in-process flag or the like. When the atomic operation performing notification is outputted, the synchronization process in-process flag or the like is initialized, and the completion of the synchronization process can be acknowledged. When the information compared with the “interrupt generating condition” is the “value after memory operation in the data storing unit 102b” and the “value after memory operation in the data storing unit 102b” is the count value of the reception frequency stored in the data storing unit 102b, the information indicating that the synchronization process is being performed can be the count value of the reception frequency.

The communication processing unit 103c not only receives the packet including the message related to the synchronization process from the other node computer, but can also receive the packet including the message related to synchronization process from its own node computer. The communication processing unit 103c can receive the packet from its own node computer based on the communication processing unit 103c being able to transmit the packet to its own node computer.

An address in the memory area in which an operation is specified by the packet including the message related to the synchronization process is a virtual address. Therefore, the communication I/F unit 103 according to the embodiment includes a conversion function that converts the virtual address into a real address. In addition, the communication I/F unit 103 outputs an instruction to the condition judging unit 103b. The instruction is for making the interrupt generating unit 103a generate an interrupt process related to data reception. Furthermore, based on the packet transmission instruction from the interrupt generating unit 103a to another node computer, the communication I/F unit 103 transmits a corresponding packet to the other node computer.

As shown in FIG. 2, in the parallel computer including the node computer 100, the node computer 200, and node computer 300 as the nodes, under the premise that the interrupt generating condition is “a memory value of a memory operation result, using an atomic operation depending on packets from both the node computers 200 and 300, is a certain value”, (1) the node computer 100 receives the packet including the message related to the synchronization process from the node computer 200. Subsequently, (2) the node computer 100 receives the packet including the message related to the synchronization process from the node computer 300.

When the packet including the message related to the synchronization process from the node computer 200 is received, the communication processing unit 103c in the node computer 100 performs the memory operation on the data storing unit 102b, performs the atomic operation on the condition judging unit 103b and gives notification of packet reception.

Then, the condition judging unit 103b judges whether the condition for generating the interrupt is fulfilled. At this time, it is judged that the condition is not yet fulfilled. Therefore, no instructions are outputted to the interrupt generating unit 103a.

Subsequently, when the packet including the message related to the synchronization process is received from the node computer 300, the communication processing unit 103c in the node computer 100 performs the memory operation on the data storing unit 102b, performs the atomic operation on the condition judging unit 103b, and gives notification of packet reception.

Then, the condition judging unit 103b judges whether the condition for generating the interrupt is fulfilled. At this time, it is judged that the condition is fulfilled. Therefore, the condition judging unit 103b outputs an instruction for generating the interrupt in the processor 101 to the interrupt generating unit 103a. The processor 101 acknowledges a termination of the series of memory operations by the generation of the interrupt and starts the predetermined process with reference to the memory value stored in the data storing unit 102b.

In this way, in the node computer according to the embodiment, the communication I/F unit 103 performs the synchronization process of the packet related to the synchronization process that is conventionally performed by the processor 101. Therefore, the disturbance in the context switch performed in the processor can be controlled. The disturbance in the context switch is caused by the interrupt generated every time the packet is received and by the synchronization process. In other words, according to the embodiment, the interrupt generated every time the packet including the message related to the synchronization process is received can be reduced to one interrupt. In addition, the synchronization process is transferred to hardware processing performed in the communication I/F unit 103 from software control performed by the processor. Therefore, the disturbance in the context switch performed in the processor can be controlled. As a result, the communication speed between the computers in the parallel computer can be improved and the processing capability of the parallel computer can be enhanced.

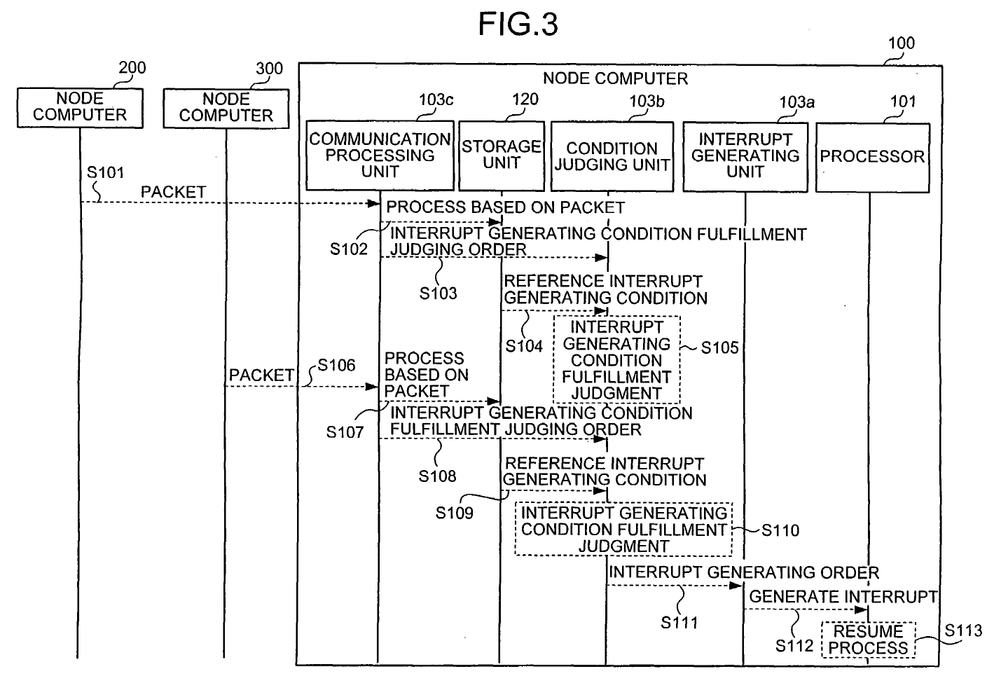

Next, the synchronization process performed in the parallel computer shown in FIG. 2 will be explained. FIG. 3 is a sequence diagram of the synchronization process performed in the parallel computer shown in FIG. 2. First, the node computer 200 transmits a packet to the communication processing unit 103c in the node computer 100. The packet is received by the communication processing unit 103c (Step S101).

The subsequent process is performed within the node computer 100. Next, the communication processing unit 103c performs a memory process on the storage unit 102 (Step S102). The memory process depends on the packet from the node computer 200. The communication processing unit 103c outputs an interrupt generating condition fulfillment judging order to the condition judging unit 103b (Step S103). Then, the condition judging unit 103b reads the interrupt generating condition from the storage unit 102 (Step S104).

Next, the condition judging unit 103b performs the interrupt generating condition fulfillment judgment (Step S105). As a result of the judgment process, it is judged that the interrupt generating condition is not fulfilled. Therefore, the condition judging unit 103b waits for the reception of the next packet related to the synchronization process.

Next, the node computer 300 transmits a packet to the communication processing unit 103c in the node computer 100. The communication processing unit 103c receives the packet (Step S106).

Next, the communication processing unit 103c performs a process on the storage unit 102 (Step S107). The memory process depends on the packet from the node computer 300. The communication processing unit 103c outputs an interrupt generating condition fulfillment judging order to the condition judging unit 103b (Step S108). Then, the condition judging unit 103b reads the interrupt generating condition from the storage unit 102 (Step S109).

Next, the condition judging unit 103b performs the interrupt generating condition fulfillment judgment (Step S110). As a result of the judgment process, at this time it is judged that the interrupt generating condition is fulfilled. Therefore, the condition judging unit 103b outputs an interrupt generating order to the interrupt generating unit 103a (Step S111). Then, the interrupt generating unit 103a generates the interrupt in the processor 101 (Step S112). The processor 101 in which the interrupt is generated starts the predetermined process with reference to the memory value stored in the data storing unit 102b (Step S113).

Conventionally, the interrupt or the event is generated in the processor every time the packet including the message related to the series of synchronization processes is received from the node computers. However, according to the embodiment, the interrupt or the event is generated in the processor only after reception of the packet including the message related to the series of synchronization processes from all node computers is acknowledged using synchronization waiting. Therefore, the disturbance in the context switch performed in the processor and a reduction in the performance of the overall parallel computer can be prevented. The disturbance is caused by the interrupt or the event.

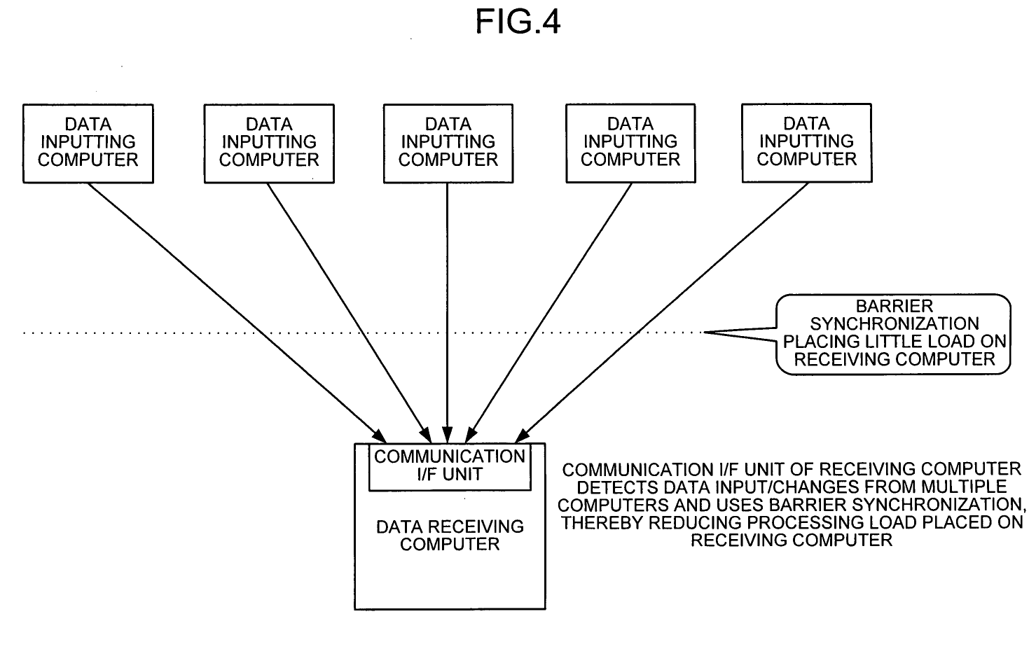

Next, an application example of the embodiment will be explained. FIG. 4 is a diagram showing the application example of the parallel computer according to the embodiment. In the parallel computer, computers including the communication I/F unit 103 shown in FIG. 2 are connected. Upon sequentially or simultaneously receiving data from a plurality of data inputting computers, a communication I/F unit in a data receiving computer detects data input from the data inputting computers or changes in the data and uses barrier synchronization. The data receiving computer performs processes based on all received data. As a result, a barrier synchronization that can reduce a load placed on a processor in the receiving computer can be actualized.

The invention is not limited to the above-described embodiment, but can be used in various differing embodiments included within the spirit and scope of the claims. The differing embodiments will be explained, below.

The interrupt generating unit 103a can make the synchronization unit perform the interrupt process in the processor based on the interrupt process generating instruction from the communication processing unit 103c. In addition, the interrupt generating unit 103a can have a function that outputs the SWR to the communication processing unit 103c. The SWR is an instruction for performing a related predetermined atomic operation stored in the storage unit 102. As a result, the communication I/F unit 103 does not require processing load to be placed on the processor 101. The required process to be performed after the synchronization process of the received packet can be completed and performed within the communication I/F unit 103.

If the communication processing unit 103c receives a packet including a message related to another synchronization process before initialization of the synchronization process in-process flag or the like, the communication processing unit 103c can ignore the packet. In addition, the communication processing unit 103c can have a function that transits an instruction for retrying packet transmission to the node computer from which the packet is transmitted. As a result, in the series of synchronization processes, exclusive control can be performed so as not to receive other packets.

According to the embodiment, the atomic operation depending on the packet can be received as long as the communication processing unit 103c in the receiving node computer acknowledges the atomic operation as a message to be subjected to the series of synchronization processes, without the transmitting node computer releasing the lock on the receiving node computer each time. Therefore, a large disturbance in the context switch performed in the processor in the transmitting node computer caused by the retry does not occur.

Although the embodiments of the invention are explained above, the invention is not limited thereto and can undergo appropriate design changes and be used within the spirit and scope of the appended claims. Effects described in the embodiments are not limited thereto.

According to the embodiments, three node computers are connected in the parallel computer to simplify the explanations. However, the invention can be similarly applied to parallel computers including two or more than three node computers.

The communication I/F unit 103 is compatible with the conventional communication I/F unit as a communication mechanism. Therefore, the node computer including the communication I/F unit 103 of the invention and the node computer without the communication I/F unit 103 can be interconnected. In this case, communication performance is degraded in the node computer without the communication I/F unit 103. For example, an interrupt related to inter-node communication is generated in the processor and a disturbance in the context switch caused by the synchronization waiting occurs. In other words, the node computer without the communication I/F unit 103 of the invention and the node computer including the communication I/F unit 103 of the invention can be combined to configure the parallel computer.

According to an aspect of the invention, the communication interface device includes a condition judging unit that judges whether a result of a memory operation performed by performing an integral operation fulfills a predetermined condition, every time an integral-operation performing unit performs the integral operation. Therefore, the communication interface device can control the synchronization waiting in which the processing of the received packet is not started until the condition is fulfilled. The processing load placed on the processor in the parallel computer can be reduced and the processing capability of the parallel computer can be enhanced.

According to another aspect of the invention, a memory operation can be performed depending on a packet received from a computer having the communication interface device, within the parallel computer. Therefore, the process can be performed by only the computer having the communication interface device when a communication function between the computers is terminated.

According to still another aspect of the invention, the communication interface device includes an interrupt generating unit that generates an interrupt in a processor in the computer to start processing of the received packet, when the condition judging unit judges that the result of the memory operation fulfills the predetermined condition. Therefore, frequent generation of the interrupt during synchronization waiting of the received packets can be suppressed. The interrupt places processing load on the processor. Moreover, the processing capability of the parallel computer can be enhanced.

According to still another aspect of the invention, the communication interface device includes a completion notification transmitting unit that transmits a completion notification to a transmitting computer transmitting the received packet, when the condition judging unit judges that the result of the memory operation fulfills the predetermined condition. Therefore, the transmitting computer transmitting the received packet can acknowledge that the result of the memory operation fulfills the predetermined condition and that the memory operation is completed.

According to still another aspect of the invention, the communication interface device includes a communication processing unit that performs a predetermined communication processing on a transmitting computer, when the condition judging unit judges that the result of the memory operation fulfills the predetermined condition. Therefore, other communication processing can be performed in connection with a completion of one synchronization waiting.

According to still another aspect of the invention, the communication interface device includes a storing unit that stores the result of the memory operation separately from update data based on the received packet. Therefore, the interrupt generating condition judgment can be performed without fail, even when the update data based on the received packet is destroyed. In addition, the communication interface device includes an initializing unit that initializes the result of the memory operation stored in the storing unit when the condition judging unit judges that the result of the memory operation fulfills the predetermined condition. Therefore, the initialization of the result of the memory operation separate from the update data based on the received packet can be performed without fail. Moreover, the result of the memory operation that is subjected to the interrupt generating condition judgment can always be kept clean.

According to still another aspect of the invention, when all received packets related to one synchronization waiting process is not received, exclusive control is performed. By the exclusive control being performed, a packet related to another synchronization waiting process is not received. Therefore, confusion occurring because of a concentration of synchronization waiting processes can be prevented. Moreover, a reduction in the processing capability of the parallel computer can be prevented. In addition, the computer transmitting the received packet related to another synchronization waiting process is notified of the termination of the packet reception. Therefore, the computer can perform a retry.

According to still another aspect of the invention, the computer transmitting the received packet related to another synchronization waiting process of which reception is terminated can retry the packet transmission. Therefore, the synchronization waiting process can be performed without fail, even when the reception of the packet is terminated.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication interface device in a computer in a parallel computer that, under a condition that a receiving computer receives data distributed and allocated to a plurality of transmitting computers as a packet, starts processing a received packet, the communication interface device comprising:
an integral-operation performing unit that performs an integral operation for performing a memory operation depending on a packet received from the transmitting computers; and
a condition judging unit that judges whether a result of the memory operation performed by integral-operation performing unit fulfills a predetermined condition, every time the integral-operation performing unit performs the integral operation.

2. The communication interface device according to claim 1, wherein the integral-operation performing unit performs an integral operation for performing a memory operation depending data transmitted from a computer having the communication interface device.

3. The communication interface device according to claim 1, further comprising an interrupt generating unit that generates an interrupt in a processor in the computer to start processing of the received packet, when the condition judging unit judges that the result of the memory operation fulfills the predetermined condition.

4. The communication interface device according to claim 1, further comprising a completion notification transmitting unit that transmits a completion notification to a transmitting computer that has transmitted the received packet, when the condition judging unit judges that the result of the memory operation fulfills the predetermined condition.

5. The communication interface device according to claim 1, further comprising a communication processing unit that performs a predetermined communication processing on a transmitting computer, when the condition judging unit judges that the result of the memory operation fulfills the predetermined condition.

6. The communication interface device according to claim 1, further comprising:
a storing unit that stores therein the result of the memory operation separately from update data based on the received packet; and
an initializing unit that initializes the result of the memory operation stored in the storing unit when the condition judging unit judges that the result of the memory operation fulfills the predetermined condition.

7. The communication interface device according to claim 6, further comprising:
a terminating unit that terminates the performance of the integral operation by the integral-operation performing unit when a packet is further received from the transmitting computer before the initializing unit initializes the result of the memory operation; and
a transmitting unit that transmits information on a termination of the performance of the integral operation by the terminating unit to the transmitting computer.

8. The communication interface device according to claim 7, further comprising a retry unit that retries data transmission to the receiving computer when the information on the termination of the performance of the integral operation transmitted by the transmitting unit is received from the receiving computer.

9. A communication method executed on a computer in a parallel computer that, under a condition that a receiving computer receives data distributed and allocated to a plurality of transmitting computers as a packet, starts processing a received packet, the communication method comprising:
performing an integral operation for performing a memory operation depending on a packet received from the transmitting computers; and
judging whether a result of the memory operation performed at the performing fulfills a predetermined condition, every time the performing is executed.

10. The communication method according to claim 9, wherein the performing includes performing an integral operation for performing a memory operation depending data transmitted from a computer having the communication interface device.

11. The communication method according to claim 9, further comprising generating an interrupt in a processor in the computer to start processing of the received packet, when it is judged at the judging that the result of the memory operation fulfills the predetermined condition.

12. The communication method according to claim 9, further comprising transmitting a completion notification to a transmitting computer that has transmitted the received packet, when it is judged at the judging that the result of the memory operation fulfills the predetermined condition.

13. The communication method according to claim 9, further comprising performing a predetermined communication processing on a transmitting computer, when it is judged at the judging that the result of the memory operation fulfills the predetermined condition.

14. The communication method according to claim 9, further comprising:
storing the result of the memory operation separately from update data based on the received packet in a storing unit; and
initializing the result of the memory operation stored in the storing unit when it is judged at the judging that the result of the memory operation fulfills the predetermined condition.

15. The communication method according to claim 14, further comprising:
terminating the performing of the integral operation when a packet is further received from the transmitting computer before the result of the memory operation is initialized at the initializing; and
transmitting information on a termination of the performance of the integral operation at the terminating to the transmitting computer.

16. The communication method according to claim 15, further comprising retrying data transmission to the receiving computer when the information on the termination of the performance of the integral operation transmitted at the transmitting is received from the receiving computer.
